(19) United States
(12) Patent Application Publication
(10) Pub. No.: US 2026/0213641 A1
(43) Pub. Date: Jul. 23, 2026

(54) CONTROLLABLE RECTIFIER ARRANGEMENT FOR HYDROGEN ELECTROLYSIS

(71) Applicant: Andritz AG, Graz (AT)

(72) Inventor: Andreas RECHBERGER, Zug (AT)

(73) Assignee: Andritz AG, Graz (AT)

(21) Appl. No.: 19/141,291

(22) PCT Filed: Nov. 9, 2023
(86) PCT No.: PCT/AT2023/060380

§ 371 Date: Jun. 19, 2025

(30) Foreign Application Priority Data
Dec. 21, 2022 (AT) A50982/2022

(51) Int. Cl. H02M 1/00; H02M 1/084; H02M 1/12; H02M 1/14

(52) U.S. Cl. CPC H02M 1/007; H02M 1/0009; H02M 1/084; H02M 1/12; H02M 1/14

(57) ABSTRACT

The invention relates to a rectifier arrangement for hydrogen electrolysis, comprising a transformer (1) with a primary winding (2) for connecting an input alternating voltage and a secondary winding (3) for providing an output alternating voltage, and comprising a rectifier (4) connected to the secondary winding (3) for generating an output direct current IDC and an output direct voltage UDC, wherein at the primary winding (2) of the transformer (1) a number N>1 of winding taps (5) are provided, and a load stage switch (6) connected to a controller (7) is provided which is designed for switching the winding taps (5) without interruption such that the transformation ratio of the transformer (1) can be switched via the controller (7) in N stages.

The invention relates to a controllable rectifier arrangement for hydrogen electrolysis.

Methods for producing hydrogen by electrolysis, in particular PEM (proton exchange membrane) electrolysis and AEL (alkaline electrolysis), are known from the prior art. Such methods require a high and substantially constant direct current, which, however, is dependent on the production conditions. This usually requires direct currents above 600 A at a power output of over 1 MW.

Controllable rectifier arrangements are known for providing direct current, which generate an output direct voltage from an input alternating voltage. Nowadays, rectifier arrangements with actively controlled electronic circuits, for example circuits with thyristors or IGBTs with or without DC/DC converters and downstream filter elements, are used for this purpose.

However, such rectifier arrangements suffer from the disadvantage that relatively high losses occur during the conversion of the input alternating voltage into the output direct voltage. Typically, total losses, including measures to ensure voltage quality and cooling, are up to 4%, which is problematic due to the high energy requirements of hydrogen electrolysis.

The object of the invention is therefore to create an improved rectifier arrangement which is in particular suitable for providing a substantially constant direct current with low residual ripple, low mains feedback and low losses for hydrogen electrolysis.

These and other objects are achieved by a rectifier arrangement according to claim 1.

A rectifier arrangement according to the invention for hydrogen electrolysis comprises a transformer with a primary winding for connecting an input alternating voltage and a secondary winding for providing an output alternating voltage, and a rectifier connected to the secondary winding for generating an output direct current I_{DC} and an output direct voltage U_{DC}. The rectifier may be designed as a passive rectifier, in particular without actively controlled electronic circuits and filter elements. Preferably, the rectifier is designed as a passive multi-pulse diode bridge rectifier, in particular in the form of a two-pulse bridge rectifier circuit. A choke coil may be arranged at the output of the rectifier to smooth the direct current.

Multiple winding taps are provided on the primary winding of the transformer, allowing the number of turns of the primary winding to be adjusted in N steps. Depending on the input alternating voltage and the transformation ratio, a number of turns of the primary winding in the range from 1000 to 1500 turns may be provided. The number of winding taps N may be greater than 10, preferably about 20. However, up to 35 winding taps may also be provided. The winding taps may be provided in a sub-section of the primary winding such that, for example, only about 200 turns out of about 1000 turns are tapped.

An on-load tap changer connected to a controller is provided, which is designed for switching the winding taps without interruption. The controller may thus use the on-load tap-changer to adjust the transformation ratio N1:N2 of the transformer, and thus the output voltage of the rectifier arrangement, in N steps. The transformation ratio is defined as the ratio of the number of turns of the primary winding to the number of turns of the secondary winding of the transformer.

The controller may be connected to a voltmeter and an amperemeter for measuring the output voltage and the output current, such that it can generate the required direct current by adjusting the on-load tap-changer in the transformer.

The advantage of the invention is that by omitting conventional rectifier arrangements with actively controlled electronic circuits and filter elements, electrical losses can be reduced and thus a more efficient provision of electrical energy can be achieved.

According to the invention, it may be provided that the rectifier arrangement allows a coarse and fine adjustment.

For this purpose, it may be provided that the primary winding comprises a first partial winding and a second partial winding connected in series, wherein a number N>1 of winding taps is provided on the first partial winding, and a number M>1 of winding taps is provided on the second partial winding. The number of turns of the first and second partial windings may be the same or different.

In this embodiment, two on-load tap-changers connected to the controller are provided. A first on-load tap changer is configured for switching of the winding taps of the first partial winding without interruption, and a second on-load tap changer is configured for switching of the winding taps of the second partial winding without interruption. The first partial winding is connected in series via the second on-load tap-changer with the second partial winding, such that the transformation ratio of the transformer is switchable in N x M steps. The number of winding taps N and M may be the same or different. The number of winding taps N and M may be greater than 10, preferably about 20. However, up to 35 winding taps may also be provided for each.

In order to enable a coarse and fine adjustment of the transformation ratio, it may be provided that the on-load tap changers switch a different number of turns per step. For example, the first on-load tap-changer may switch a higher number of turns per step than the second on-load tap-changer. Thus, the first on-load tap-changer may effect coarse adjustment and the second on-load tap-changer may effect fine adjustment of the transformation ratio.

This may be achieved by the on-load tap-changers having an identical number of winding taps, wherein, however, the number of turns of the first partial winding is higher than the number of turns of the second partial winding. As a result, the transformation ratio can be adjusted via the on-load tap-changers in N coarse steps and M fine steps. For example, the output voltage can be set in 361 steps when N=M=19, wherein, however the steps are not equal in size due to the different number of turns per step of the coarse and fine adjustment.

On the other hand, it may also be provided that the number of turns of the partial windings are identical, but the on-load tap-changers have different numbers of winding taps. For example, the number of winding taps of the first on-load tap-changer N may be greater than the number of winding taps of the second on-load tap-changer M. Thus, the transformation ratio is adjustable in M coarse steps and N fine steps.

These embodiments may also be combined, wherein the partial windings have different numbers of turns and the on-load tap-changers have a different number of winding taps. Essential for the implementation of coarse and fine adjustment of the transformation ratio is only that the number of switched turns of the on-load tap-changers for coarse and fine adjustment is different.

By using such cascaded step switches, both the normal control range and stronger overvoltages and undervoltages on the mains side can be covered (+/−10% of the input voltage). Further, the step adjustment in the control range may be very fine, while the coarse steps may be approached very quickly in order to make greater adjustments.

The number and distribution of the steps between fine and coarse steps may be individually adapted to the area of application, wherein experience has shown that more than 125 steps are required for the use according to the invention in hydrogen electrolysis. Switching from one step to the next step under load may take up to multiple seconds, which, however, does not pose a problem for the application in hydrogen electrolysis.

According to the invention, it may be provided that the transformer is designed as a multi-phase, in particular as a three-phase transformer. In this embodiment, a 3-phase voltage serves as the input voltage, wherein the primary windings are connected in a star or delta configuration. A number N>1 of winding taps are provided on each primary winding, and three on-load tap-changers connected to the controller are provided, which are adapted for switching the winding taps without interruption. The on-load tap-changers may be designed substantially identical. Instead of multiple single-phase on-load tap-changers, a multi-phase on-load tap-changer may also be provided.

The secondary windings may also be connected in a star or delta configuration. Further, in this embodiment, a multi-phase bridge rectifier, in particular in the form of a six-pulse bridge circuit (B6U circuit), may be provided for generating an output direct voltage. Again, a controller is provided that is connected to a voltmeter and an amperemeter for measuring the output voltage and the output current, such that it can generate the required direct current by adjusting the three on-load tap-changers in the transformer. A choke coil may again be arranged at the output of the bridge rectifier to smooth the direct current.

According to the invention, a coarse and fine adjustment of the transformation ratio may also be provided when using a three-phase transformer. Additionally, the primary windings may each comprise a first partial winding and a second partial winding, wherein a number N>1 of winding taps are provided on each of the first partial windings, and a number M>1 of winding taps are provided on each of the second partial windings. In this case, first on-load tap-changers are provided for coarse adjustment, which are connected to the controller and are adapted for switching the winding taps of the first partial windings without interruption.

In this case, second on-load tap-changers are provided for fine adjustment, which are connected to the controller and are adapted for switching the winding taps of the second partial winding without interruption. The first partial windings are connected in series with the second partial windings via the first on-load tap-changers, such that the transformation ratio of the transformer and thus the output direct voltage is again adjustable in M×N steps.

In order to achieve better rectification of the transformer output voltages and to reduce AC mains feedback, it may be provided that two or more secondary winding arrangements are provided, each comprising three secondary windings connected in a star or delta configuration. The secondary winding arrangements may in particular be adapted to generate output voltages that are phase-shifted by an angle Δφ. This allows for the use of multiple separate rectifiers for the phase-shifted output voltages, such that the output alternating voltage has lower ripple and lower harmonic mains feedback. In this case, it may be possible to omit the use of a choke coil to smooth the output direct current.

According to the invention, it may be provided that the output voltages of the secondary winding arrangements are phase-shifted by a phase angle of Δφ>0°.

The value of Δφ is calculated from Δφ=60° divided by the number of secondary winding arrangements. Thus, with four secondary winding arrangements, the value Δφ is about 15°.

According to the invention, it may be provided that three, four, five or six secondary winding arrangements are provided. These may have secondary windings connected in a star configuration or in a delta configuration, which are interconnected with a phase displacement Δφ such that the harmonics generated on the primary side cancel each other out as effectively as possible.

Preferably, a separate rectifier is provided for each secondary winding arrangement. The rectifiers may be connected in series to generate the output direct voltage. However, the rectifiers may also be connected in parallel to generate the output direct voltage.

The rectifiers may be provided as multi-phase diode bridge rectifiers, in particular as a six-pulse bridge circuit with 6 diodes (B6U circuit). The number of B6U circuits may depend on the respective requirements for the quality of the output direct voltage and the output direct current. For example, four B6U circuits may be provided to achieve a ripple value of the output direct current of less than 1.2%, resulting in an effective pulse number of 24. In this case, the use of a choke coil on the secondary side may not be necessary.

For a pulse number of 12, two phase-shifted secondary winding arrangements may be provided. For a pulse number of 18, three phase-shifted secondary winding arrangements may be provided.

For a pulse number of 24, four phase-shifted secondary winding arrangements may be provided. For a pulse number of 30, five phase-shifted secondary winding arrangements may be provided. For a pulse number of 36, six phase-shifted secondary winding arrangements may be provided.

The secondary winding arrangements may each have a star configuration or a delta configuration, with a corresponding phase displacement Δφ to cancel out harmonic mains feedback.

For example, the input alternating voltage may have an amplitude of more than 10 kV, in particular about 20 kV to 30 kV. Depending on the stack type and the number of electrolysis cells to be supplied, the output direct voltage may have a level of 300 V to 1500 V, for example about 625 V.

The transformation ratio may be adjustable, for example, by a nominal value of about N1:N2=48. Of course, other, in particular higher values of the transformation ratio are also possible. For example, a transformation ratio of N1:N2=190 may be provided for transforming an input alternating voltage of about 30 kV to an output alternating voltage of about 160 V. The adjustable range may be +/−10%, for example. A coarse adjustment of +/−10% and a fine adjustment of +/−1% may also be provided, wherein in both cases a number M, N>15 steps may be provided. In particular, it may be provided that about 20 to 40 turns per step are switched for the coarse adjustment. To enable fine adjustment, it may be provided that the on-load tap-changer is adapted to switch from one to ten turns per step, in particular a single turn per step.

Depending on the electrolysis stack, the transformer may have a nominal electrical power of about 6 MVA. When the secondary side is divided into multiple secondary winding arrangements, the nominal power can be divided accordingly, such that, for example, three or four secondary winding arrangements with a nominal power of about 2 MVA or 1.5 MVA each are provided.

According to the invention, it may further be provided that the rectifier arrangement comprises two or more transformers, wherein the output voltages of the transformers are phase-shifted by an angle Ao and wherein for each of the transformers a dedicated rectifier is provided for generating the output direct current I_{DC} and the output direct voltage U_{DC}.

The transformers and the associated rectifiers may be designed as single-phase or multi-phase units, in particular as three-phase units.

In contrast to the use of a multi-pulse transformer with two or more phase-shifted secondary winding arrangements, this allows for a simpler structure of the transformers. Only a single secondary winding arrangement is required per transformer, which may optionally be designed with a primary winding and at least one partial winding for implementing a coarse and fine adjustment. To achieve a reduced ripple of the output voltage, the transformers are designed to be phase-shifted. It may be provided that the transformers are adapted to achieve an output voltage phase-shifted by an angle of Δφ, wherein Δφ is equal to 60° divided by the number of transformers. For example, a 24-pulse circuit may be implemented with four transformers, four dedicated rectifier bridges, and two tap-changers per transformer.

Such a rectifier arrangement may be used in particular for power outputs of 10 MW to 50 MW, since the construction and transport of multi-pulse transformers in this magnitude is difficult. Further, an additional load balancing control can be implemented in a simple manner by adjusting each bridge current of the rectifier bridges via the fine-tap-changers. The setpoint of the generated direct currents may therefore be distributed evenly to the individual rectifier bridges by fine control of the tap-changers of the transformer's partial windings, such that mains feedback and ripple are reduced. The arrangement of balancing reactors may be avoided and the rectifier bridges may be manufactured more simply.

The invention further relates to the use of a rectifier arrangement according to the invention for generating an output direct current IDC of more than about 600 A, preferably more than about 2000 A at an output direct voltage in the range of about 300 V to about 1500 V for hydrogen electrolysis, in particular PEM electrolysis or alkaline electrolysis.

Further features according to the invention emerge from the claims, the description of the exemplary embodiments and the figures. The invention is discussed below with reference to figures showing exemplary embodiments:

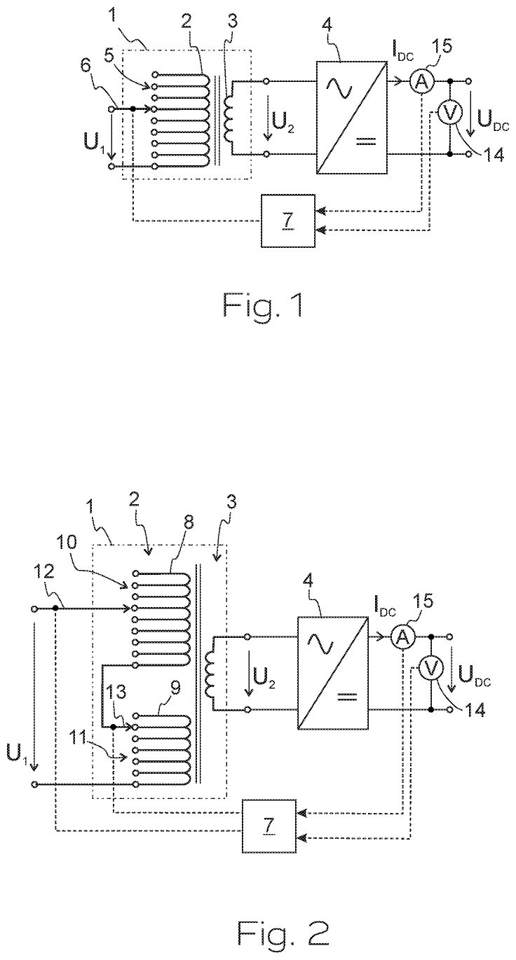

FIG. 1 shows a first exemplary embodiment of a rectifier arrangement according to the invention;

FIG. 2 shows a second exemplary embodiment of a rectifier arrangement according to the invention;

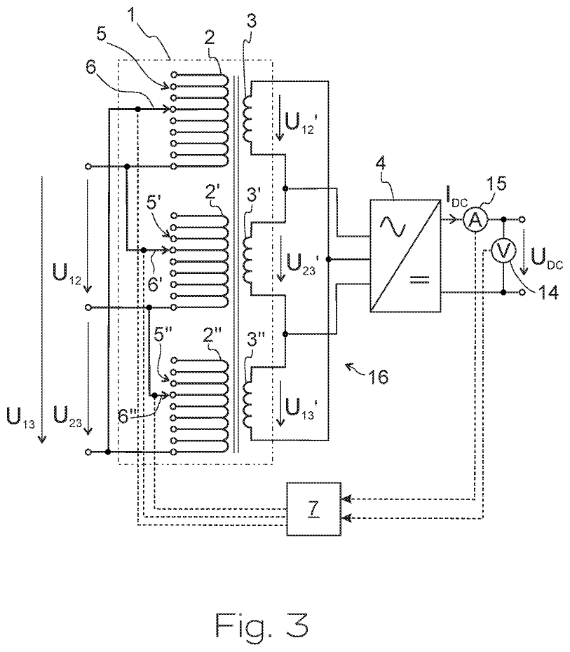

FIG. 3 shows a third exemplary embodiment of a rectifier arrangement according to the invention;

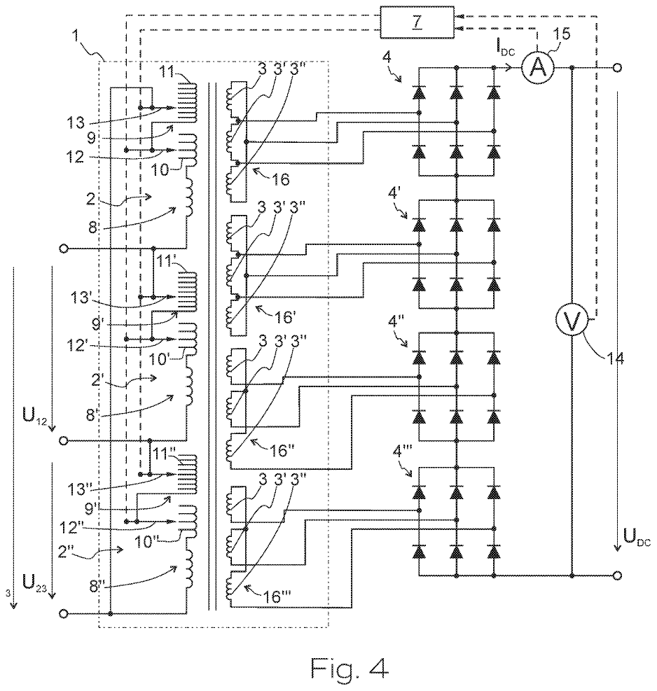

FIG. 4 shows a fourth exemplary embodiment of a rectifier arrangement according to the invention;

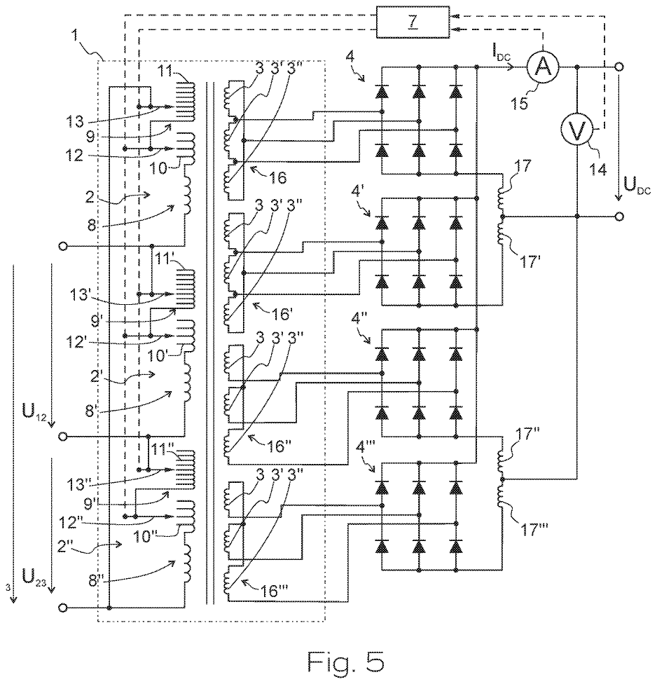

FIG. 5 shows a fifth exemplary embodiment of a rectifier arrangement according to the invention;

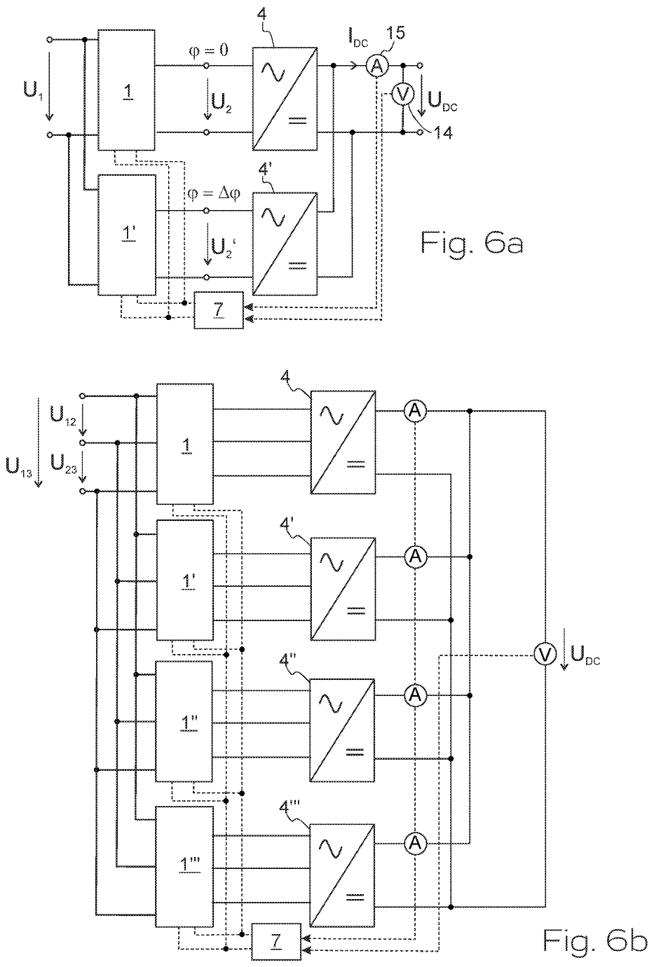

FIGS. 6a-6b show further exemplary embodiments of a rectifier arrangement according to the invention.

FIG. 1 shows a first exemplary embodiment of a rectifier arrangement according to the invention for hydrogen electrolysis. It comprises a transformer 1 with a primary winding 2 for connecting an input alternating voltage U₁, a secondary winding 3 for providing an output alternating voltage U₂, and a rectifier 4 connected to the secondary winding 3 for generating an output direct current loc and an output direct voltage U_{DC}. A PEM stack (not illustrated) is connected to the output of the rectifier to generate hydrogen.

At the primary winding 2 of the transformer 1 a number N=8 of winding taps 5 are provided. An on-load tap changer 6 connected to a controller 7 is provided, which is adapted for switching the winding taps 5 without interruption, such that the transformation ratio of the transformer 1 is switchable in 8 steps via the controller 7.

The controller 7 is connected via data lines to a voltmeter 14 and an amperemeter 15 on the output side of the rectifier 4.

In this exemplary embodiment, the rectifier 4 is provided as single-phase diode bridge rectifier. The controller 7 receives a desired output direct current as the target value and adjusts the on-load tap-changer 6 on the primary side of the transformer 1 such that this value is achieved at the output of the rectifier 4.

FIG. 2 shows a second exemplary embodiment of a rectifier arrangement according to the invention. In this exemplary embodiment, the primary winding 2 comprises a first partial winding 8 and a second partial winding 9, wherein a number N=8 winding taps 10 are provided on the first partial winding 8 and a number M=6 winding taps 11 are provided on the second partial winding 9.

A first on-load tap-changer 12 is provided, which is connected to a controller 7 and configured to switch between the winding taps 10 of the first partial winding 8 without interruption. Further, a second on-load tap-changer 13 provided, which is connected to the controller 7 and configured to switch between the winding taps 11 of second partial winding 9 without interruption. The controller 7 is connected to both on-load tap-changers 12, 13 via data lines and may actuate them.

The first partial winding 8 is connected in series with the second partial winding 9 via the second on-load tap-changer 13. As a result, the partial windings 8, 9 are cascaded such that the transformation ratio of the transformer 1 is switchable in 8×6=48 steps. In this example, the number of turns of the first partial winding 8 is identical to the number of turns of the second partial winding 9, such that the first on-load tap-changer 12 switches fewer turns per step than the second on-load tap-changer 13. The second on-load tap-changer 13 thus provides coarse adjustment and the first on-load tap-changer provides fine adjustment of the transformation ratio U₁:U₂.

In this exemplary embodiment, the rectifier 4 is provided a as single-phase diode bridge rectifier. The controller 7 is connected via data lines to a voltmeter 14 and an amperemeter 15 on the output side of the rectifier 4. The controller 7 receives a desired output direct voltage or a desired output direct current as the target value and adjusts the on-load tap-changers 12, 13 on the primary side of the transformer 1 such that these values are achieved at the output of the rectifier 4.

FIG. 3 shows a third exemplary embodiment of a rectifier arrangement according to the invention. In this exemplary embodiment, a three-phase transformer is used to transform a three-phase input alternating voltage U₁₂, U₂₃, U₁₃ into a three-phase output alternating voltage U₁₂′, U₂₃′, U₁₃′. In the present exemplary embodiment, the primary windings 2, 2′, 2″ and the secondary windings 3, 3′, 3″ are connected in a delta configuration. Again, a number N=8 winding taps 5, 5′, 5″ are provided on each primary winding 2, 2′, 2″.

Three on-load tap-changers 6, 6′, 6″ connected to the controller 7 are adapted for switching these winding taps 5, 5′, 5″ on the primary side of the transformer without interruption, such that the controller 7 can adjust the transformation ratio of the transformer U₁₂:U₁₂′=U₂₃:U₂₃′=U₁₃:U₁₃′ in N=8 steps, wherein the steps are of different sizes.

The three secondary windings 3, 3′, 3″ are connected in a delta configuration and form a secondary winding arrangement 16. In an embodiment of the invention that is not illustrated, the primary windings 2, 2′, 2″ as well as the secondary windings 3, 3′, 3″ are connected in a star configuration.

In this exemplary embodiment, the rectifier 4 is provided as three-phase diode bridge rectifier. The controller 7 is again connected via data lines to a voltmeter 14 and an amperemeter 15 on the output side of the rectifier 4.

The controller 7 receives a desired output direct voltage or a desired output direct current as the target value and adjusts the on-load tap-changers 6, 6′, 6″ on the primary side of the transformer 1 such that these values are achieved at the output of the rectifier 4.

FIG. 4 shows a fourth exemplary embodiment of a rectifier arrangement according to the invention. In this exemplary embodiment, a three-phase transformer is used to transform a three-phase input alternating voltage into a three-phase output alternating voltage. In the present exemplary embodiment, the primary windings 2, 2′, 2″ and the secondary windings 3, 3′, 3″ are connected in a delta configuration.

The primary windings 2, 2′, 2″ each comprise a first partial winding 8, 8′, 8″ and a second partial winding 9, 9′, 9″. A number N=4 of winding taps 10, 10′, 10″ are provided on each of the first partial windings 8, 8′, 8″. A number M=8 of winding taps 11, 11′, 11″ are provided on each of the second partial windings 9, 9′, 9″. Each partial winding may again be divided into multiple individual windings.

Three first on-load tap-changers 12, 12′, 12″ are provided, which are connected to the controller 7 via data lines and are adapted for switching the winding taps 10, 10′, 10″ of the first partial windings 8, 8′, 8″ without interruption. The first three on-load tap-changers 12, 12′, 12″ may also be implemented as a single three-phase on-load tap-changer.

Further, three second on-load tap-changers 13, 13′, 13″ are provided, which are connected to the controller 7 via data lines and are adapted for switching the winding taps 11, 11′, 11″ of the second partial windings 9, 9′, 9″ without interruption. The second three on-load tap-changers 13, 13′, 13″ may also be implemented as a single three-phase on-load tap-changer.

The first partial windings 8, 8′, 8″ are connected in series with the second partial windings 9, 9′, 9″ via the first on-load tap-changers 12, 12′, 12″, resulting in cascading of the first and second partial windings, and the transformation ratio of the transformer 1 is switchable in M×N=8×4=32 steps. Thus, the controller 7 may adjust the transformation ratio of the transformer 1 in 32 steps, wherein the steps are of different sizes.

In embodiments of the invention that are not illustrated, the values of N and M are greater than 15, in particular greater than 20, such that the controller 7 may adjust the transformation ratio of the transformer 1 in more than 225, in particular in more than 400 steps.

In the illustrated embodiment the primary windings 2, 2′, 2″ are connected in a delta configuration. On the secondary side, four secondary winding arrangements 16, 16′, 16″, 16″, each electrically phase-offset by 15°, are provided. The phase displacements are, for example, +22.5°, +7.5°, −7.5°, −22.5° relative to the primary side. The secondary windings 3, 3′, 3″ of the first two secondary winding arrangements 16, 16′ are connected in a delta configuration. The secondary windings 3, 3′, 3″ of the third and fourth secondary winding arrangements 16, 16′ are connected in a star configuration.

Each of the four secondary winding arrangements 16, 16′, 16″, 16″ is connected to a rectifier 4, 4′, 4″, 4′″. In this exemplary embodiment, the rectifiers 4, 4′, 4″, 4′″ are provided as three-phase diode bridge rectifiers, each with six diodes, such that a 24-pulse rectification of the input alternating voltage is achieved.

In embodiments of the invention that are not illustrated, two, three, five or six secondary winding arrangements, each with a three-phase diode bridge rectifier with six diodes, may be combined such that 12-, 18-, 30- or 36-pulse rectification of the input alternating voltage is achieved.

In this exemplary embodiment, the transformer 1 has a nominal electrical power of about 6 MVA at an input voltage of about 30 kV. By dividing the secondary side into four secondary winding arrangements 16, 16′, 16″, 16′″, the rated power is divided into approximately 1.5 MVA each.

The controller 7 is again connected via data lines to a voltmeter 14 and an amperemeter 15 on the output side of the rectifier 4.

The controller 7 receives a desired output direct voltage or a desired output direct current as a target value and adjusts the first on-load tap-changers 12, 12′, 12″ and the second on-load tap-changers 13, 13′, 13″ on the primary side of the transformer 1 in such a way that the desired values are reached at the output of the rectifier 4.

FIG. 5 shows a fifth exemplary embodiment of a rectifier arrangement according to the invention. The exemplary embodiment corresponds to that in FIG. 4, with the difference that the secondary winding arrangements 16, 16′, 16″, 16′″ are connected in parallel. As a result, the voltage of the secondary winding arrangements is higher and a lower transformation ratio N1:N2 is required. Again, the secondary winding arrangements 16, 16′, 16″, 16′″ are designed with a phase offset of 15° each. The rectifiers 4, 4′, 4″, 4′″ are again provided as three-phase diode bridge rectifiers, each with six diodes, such that a 24-pulse rectification of the input alternating voltage is achieved. Interphase transformers (IPT) with coils 17, 17′, 17″, 17′″ are provided in the output lines to balance the direct currents supplied by the four parallel-connected, phase-shifted rectifiers before they are combined.

FIG. 6a shows a further exemplary embodiment of a rectifier arrangement according to the invention. In this exemplary embodiment, two single-phase transformers 1, 1′ are provided, whose output voltages are phase-shifted by an angle Δφ=30°.

Each transformer 1, 1′ is designed in accordance with the exemplary embodiment in FIG. 2 and comprises a primary winding 2 divided into two partial windings 8, 9 and correspondingly cascaded on-load tap-changers 12, 13. The output alternating voltages U₂, U₂′ of the transformers 1, 1′ are converted into a direct voltage by dedicated rectifiers 4, 4′, wherein the rectifiers 4, 4′ are again provided as passive bridge rectifiers. A separate rectifier 4, 4′ is provided for each of the transformers 1, 1′ to generate the output direct current loc and the output direct voltage U_{DC}. A controller 7 is again connected via data lines to a voltmeter 14 and an amperemeter 15 on the output side of the rectifiers 4, 4′.

FIG. 6b shows a further exemplary embodiment of a rectifier arrangement according to the invention substantially corresponding to the exemplary embodiment in FIG. 6a. In this exemplary embodiment, four multi-phase transformers 1, 1′, 1″, 1′″ are provided, whose output voltages are phase-shifted by an angle Δφ=15°. According to the exemplary embodiment shown in FIG. 4, each transformer 1, 1′, 1″, 1′″ is provided with a primary winding 2, 2′, 2″ divided into two partial windings 8, 8′, 8″, 9, 9′, 9″ and correspondingly cascaded on-load tap-changers 12, 12′, 12″, 13, 13′, 13″. The output alternating voltages of the transformers 1, 1′, 1″, 1′″ are converted into a direct voltage by dedicated rectifiers 4, 4′, 4″, 4′″, wherein the rectifiers 4, 4′, 4″, 4′″ are again provided as passive bridge rectifiers. A separate rectifier 4, 4′, 4″, 4′″ is provided for each of the transformers 1, 1′, 1″, 1′″ to generate the output direct current I_{DC} and the output direct voltage U_{DC}. A controller 7 is again connected via data lines to a voltmeter 14 and an amperemeter 15 on the output side of the rectifiers 4, 4′.

The invention is not limited to the present illustrated exemplary embodiments, but rather comprises all rectifier arrangements in the scope of the following claims.

### LIST OF REFERENCE NUMBERS

1, 1′, 1″, 1′″ Transformer
2, 2′, 2″ Primary winding
3, 3′, 3″ Secondary winding
4, 4′, 4″, 4′″ Rectifier
5, 5′, 5″ Winding taps of the primary windings
6, 6′, 6″ On-load tap changer of the primary windings
7 Controller
8, 8′, 8″ First partial winding
9, 9′, 9″ Second partial winding
10, 10′, 10″ Winding taps of the first partial winding
11, 11′, 11″ Winding taps of the second partial winding
12, 12′, 12″ On-load tap changer of the first partial winding
13, 13′, 13″ On-load tap changer of the second partial winding
14 Voltmeter
15 Amperemeter
16, 16′, 16″, 16′″ Secondary winding arrangement
17, 17′, 17″, 17′″ Interphase transformer coil

1-19. (canceled)

20. A method of controlling electrical current for hydrogen electrolysis, the method comprising:
providing a rectifier arrangement comprising: a transformer having a primary winding for connecting an input alternating voltage and a secondary winding for providing an output alternating voltage, and a rectifier connected to the secondary winding, wherein the rectifier comprises a single-phase or multi-phase passive diode bridge rectifier;
configuring the primary winding to comprise a first partial winding having N winding taps where N>1, and a second partial winding having M winding taps where M>1;
providing a first on-load tap-changer connected to a controller and configured to switch the winding taps of the first partial winding without interruption;
providing a second on-load tap-changer connected to the controller and configured to switch the winding taps of the second partial winding without interruption;
connecting the first partial winding in series with the second partial winding via the second on-load tap-changer such that a transformation ratio of the transformer is switchable in N×M steps;
generating an output direct current IDC of more than about 600 A at an output direct voltage UDC in the range of about 300 V to 1500 V for hydrogen electrolysis; and
controlling the output direct current by operating the controller to adjust the on-load tap-changers through a coarse adjustment to +/−10% and through a fine adjustment to +/−1%.

21. The method of claim 20, wherein controlling the output direct current comprises switching different numbers of turns via the on-load tap-changers per step, such that the transformation ratio is adjusted in coarse steps and in fine steps.

22. The method of claim 20, wherein providing the rectifier arrangement comprises providing a multi-phase transformer with primary windings connected in a star or delta configuration and secondary windings connected in a star or delta configuration, providing N winding taps where N>1 on each primary winding, and providing one multi-phase or multiple single-phase on-load tap-changers connected to the controller for switching the winding taps without interruption.

23. The method of claim 22, wherein:
configuring the primary windings comprises providing each primary winding with a first partial winding and a second partial winding;
providing N winding taps where N>1 on each of the first partial windings, and providing M winding taps where M>1 on each of the second partial windings;
providing first on-load tap-changers connected to the controller for switching the winding taps of the first partial windings without interruption;
providing second on-load tap-changers connected to the controller for switching the winding taps of the second partial windings without interruption; and
connecting the first partial windings in series with the second partial windings via the first on-load tap-changers such that the transformation ratio of the transformer is switchable in M×N steps.

24. The method of claim 22, wherein providing the rectifier arrangement comprises providing two or more secondary winding arrangements, each comprising three secondary windings connected in a star or delta configuration with phase displacement, and generating output voltages that are phase-shifted by an angle Δφ.

25. The method of claim 24, wherein generating the output voltages comprises phase-shifting the output voltages of the secondary winding arrangements by an angle Δφ equal to 60° divided by the number of secondary winding arrangements.

26. The method of claim 24, wherein providing the rectifier arrangement comprises providing three, four, five or six secondary winding arrangements.

27. The method of claim 24, wherein providing the rectifier arrangement comprises providing a separate rectifier for each secondary winding arrangement, and connecting the rectifiers in series.

28. The method of claim 24, wherein providing the rectifier arrangement comprises providing a separate rectifier for each secondary winding arrangement, and connecting the rectifiers in parallel.

29. The method of claim 20, wherein controlling the output direct current comprises connecting the controller to an amperemeter for measuring the output current IDC and optionally to a voltmeter for measuring the output direct voltage UDC.

30. The method of claim 20, wherein providing the rectifier arrangement comprises providing an input alternating voltage having an amplitude of more than 10 kV, and generating an output direct voltage having a nominal value of about 300 V to about 1500 V.

31. The method of claim 20, wherein controlling the output direct current comprises adjusting the transformation ratio by a nominal value of at least about N1:N2=48.

32. The method of claim 20, wherein providing the rectifier arrangement comprises providing a transformer having a nominal electrical power of more than about 1 MVA.

33. The method of claim 20, wherein controlling the output direct current comprises operating the on-load tap-changers to switch less than ten turns per step to enable fine adjustment.

34. The method of claim 20, wherein providing the rectifier arrangement comprises providing two or more transformers with output voltages that are phase-shifted by an angle Δφ, and providing a rectifier for each transformer for generating the output direct current IDC and the output direct voltage UDC, wherein the transformers and the rectifiers are multi-phase units.
